(19) United States
(12) Patent Application Publication
(10) Pub. No.: US 2025/0047692 A1
(43) Pub. Date: Feb. 6, 2025

(54) ARRANGEMENT AND METHOD OF THREAT DETECTION IN A COMPUTER OR COMPUTER NETWORK

(71) Applicant: WithSecure Corporation, Helsinki (FI)

(72) Inventors: Broderick AQUILINO, Helsinki (FI); Pavel TURBIN, Helsinki (FI)

(21) Appl. No.: 18/792,214

(22) Filed: Aug. 1, 2024

(30) Foreign Application Priority Data
Aug. 4, 2023 (GB) 2311959.7

(51) Int. Cl. H04L 9/40

(52) U.S. Cl. CPC H04L 63/1416

(57) ABSTRACT

An arrangement (410) and a method, e.g. a computer implemented method, of threat detection in a computer or computer network, includes determining that an application is starting at a computer (1), such as a network node or an endpoint, monitoring the application for a predetermined duration after the application start in order to recognize malicious activity by the application. The monitoring of the application includes monitoring the application for accessing a predefined storage area, e.g. a security sensitive area, of the computer, and if access to the predefined storage area, e.g. the security sensitive area, of the computer is determined during the monitoring, denying access to the predefined storage area of the computer for the monitored application and/or denying or throttling network access of the monitored application.

### TECHNICAL FIELD

The present invention relates to an arrangement and a method of threat detection in a computer or computer network.

### BACKGROUND

Malware detection and scanning is a vital issue for the security of any kind of endpoints and networks. Malware detection and scanning is generally directed to identify and potentially also disinfect any kind of malware on computer and/or communication systems, such as e.g. viruses, Trojans, worms, or other kinds of security threats.

Antimalware file scanning is commonly a slow process and usually also depends on how reliable results are desired. One of highest accuracy method for recognizing clean or malicious files or applications is to run the file or application to be analyzed in a managed environment and later analyze its application activity. When a malware is detected, it has to be removed from a device. One of significant challenges in malware removal is to find the settings changed by malware and distinct them from legit changes made by a user and/or an administrator of a device or a system.

As long as a malicious application is able to run in the computer, it can access sensitive areas of the computer, e.g. comprising user's sensitivity information. The malicious application can for example upload sensitive data stored on the computer to a malicious server, such as a criminal site. And even if malware can be removed, the sensitive data can't be retrieved back from a malicious site or server once it has been sent away from the computer by the malicious application. In this case there is a risk of data leak which may leak user sensitive data.

Therefore, it would be desirable to enable an efficient malware detection solution which is also able to prevent data leaks carried out by malicious applications.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

According to a first aspect, the invention relates to a method, e.g. a computer implemented method, of threat detection in a computer or computer network, wherein the method comprises determining that an application is starting at a computer, such as a network node or an endpoint, and monitoring the application after the application start, e.g. for a predetermined duration, in order to recognize malicious activity by the application. The monitoring of the application comprises monitoring the application for accessing a predefined storage area, e.g. a security sensitive area, of the computer, and if access to the predefined storage area, e.g. the security sensitive area, of the computer is determined during the monitoring, denying access to the predefined storage area of the computer for the monitored application and/or denying or throttling network access of the monitored application.

In one embodiment of the invention, if no malicious activity is recognized to be carried out by the monitored application during the predefined duration, stopping monitoring and allowing access to predefined storage area and/or allowing network access of the monitored application and/or stopping the throttling of the network access.

In one embodiment of the invention, based on the determined starting of the application, intercepting the application start, identifying the application, checking reputation rating of the application and if the reputation rating of the application is unrated or unknown, allowing the application to start and staring monitoring of the application.

In one embodiment of the invention, based on the determined starting of the application, intercepting the application start, identifying the application, checking reputation rating of the application and if the reputation rating of the application is unrated or unknown, creating a backup of the computer.

In one embodiment of the invention checking reputation rating of the application comprises receiving application reputation information from a database, e.g. a backend system reputation database, based on identification and/or signatures of the application.

In one embodiment of the invention the application is monitored by tracking events created by the monitored application, such as created or changed files, accesses to registry, changes done to registry, created processes, created child processes, injection of processes in other processes, and/or by analyzing captured events to be malicious, e.g. by recognizing known patterns of file encryption, preventing malware detection by the application.

In one embodiment of the invention, if malicious activity by the application is determined when the application is running and/or if the application is accessing the predefined storage area, stopping the application, removing the application and/or reverting changes made to the computer based on the backup of the computer, the backup being prepared when the application was starting.

In one embodiment of the invention the backup comprises at least one of the following: current system settings, application settings, security settings, DNS-settings, scheduled tasks, settings related to backups or shadow copy of the computer.

In one embodiment of the invention the predefined storage area or areas, e.g. security sensitive data area or areas, comprise at least one of the following: computer user's documents and data, password data, key storage data, memory state of an application, such as memory state of a browser, memory state of a password manager, memory state of an encryption services, computer registry data, windows registry data, registry data containing password information and/or token information. In one embodiment of the invention the predefined storage area or areas are located on a computer storage means and/or storage media, e.g. secondary storage, such as mass storage and/or mass storage means. In one embodiment of the invention the predefined storage area or areas are not located in main memory areas of the computer, such as random access memory.

According to a second aspect, the invention relates to an arrangement for threat detection in a computer or computer network, wherein the arrangement comprises at least one computer, such as a network node or an endpoint, wherein the computer is configured to determine that an application is starting at a computer, such as a network node or an endpoint, and to monitor the application after the application start, e.g. for a predetermined duration, in order to recognize malicious activity by the application. The monitoring of the application comprises monitoring the application for accessing a predefined storage area, e.g. a security sensitive area, of the computer, and if access to the predefined storage area, e.g. the security sensitive area, of the computer is determined during the monitoring, the computer is configured to deny access to the predefined storage area of the computer for the monitored application and/or to deny or throttle network access of the monitored application.

In one embodiment of the invention the arrangement is configured to carry out a method according to any embodiment of the invention.

According to a third aspect, the invention relates to a computer program comprising instructions which, when executed by a computer, cause the computer to carry out a method according to the invention.

According to a fourth aspect, the invention relates to a computer-readable medium comprising the computer program according to the invention.

With the solution of the invention, it's possible to implement an efficient malware detection solution which is able to prevent data leaks e.g. relating to sensitive data of the user of the computer. This is very important as leaked data may cause for example unrecoverable reputation and financial impacts. At the same time, the aim of the solution is to have as little impact as possible to the monitored application so that the monitoring of the application is not disturbing user experience of the users of the computer.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated.

Furthermore, it is to be understood that the use of “a” or “an”, i.e. a singular form, throughout this document does not exclude a plurality.

### BRIEF DESCRIPTION OF THE DRAWINGS

The embodiments of the invention are illustrated by way of example, and not by way of limitation, in the figures of the accompanying drawings.

FIG. 1 presents as a schematic diagram a computer system or computer network configuration, for which exemplifying embodiments of the present invention are applicable.

FIG. 2 presents schematically an example embodiment of a solution of the present invention.

FIG. 3 presents an example method according to one embodiment of the invention.

FIG. 4 presents as a schematic diagram an example of a structure of an arrangement according to exemplifying embodiments of the present invention.

### DETAILED DESCRIPTION

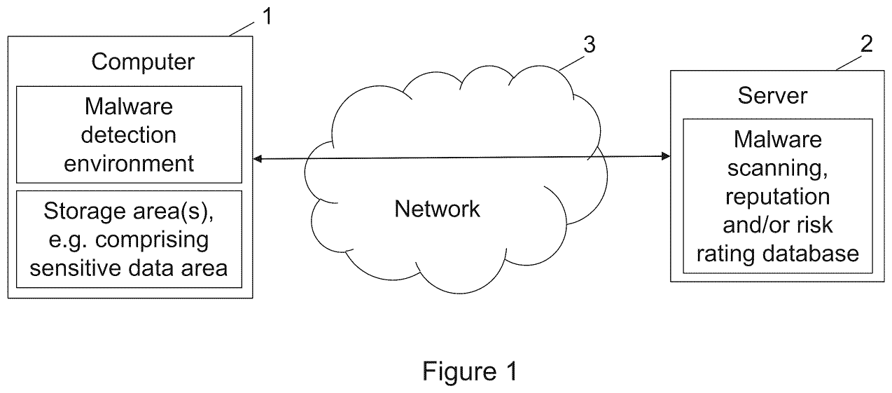

FIG. 1 presents an environment in which the solution of the invention can be used. In the solution of FIG. 1 a system configuration is presented in which a local computer 1 and a remote entity or server 2 are connected via a network 3. Here, the computer 1 exemplifies any host, computer or communication system, including a single device, a network node or a combination of devices, on which malware detection is to be performed. The malware detection can be done at the host and/or at the server. For example, the computer 1 may include a host, a personal computer, a personal communication device, a network-enabled device, a client, a firewall, a mail server, a proxy server, a database server, or the like. The server 2 exemplifies any computer or communication system, including a single device, a network node or a combination of devices, on which malware detection can be performed for the computer 1, or which can provide data for the computer 1 required to carry out the malware detection at the host, such as risk rating and/or reputation data. For example, the server 2 may include a security entity or a backend entity of a security provider, or the like, and the server 2 may be realized in a cloud implementation or the like.

According to exemplifying embodiments of the invention, malware detection at the computer 1 and/or by the server 2 can be realized using a malware analysis environment, such as a virtual machine or emulator environment, can be arranged at the computer and/or at the server. For example, a malware detection agent or sensor, such as e.g. an anti-virus software can be installed/arranged at the computer 1 to be used for malware scanning. In one embodiment of the invention a sensor or agent at the computer is used to allow to intercept a file, a system configuration value and/or network operations called by the application. The sensor can be used to observe operation of the device, such as a computer, and information collected by the sensor can be used to detect malicious behavior of an application, a file and/or a process.

The network 3 exemplifies any computer or communication network, including e.g. a (wired or wireless) local area network like LAN, WLAN, Ethernet, or the like, a (wired or wireless) wide area network like WiMAX, GSM, UMTS, LTE, or the like, and so on. Hence, the computer 1 and the server 2 can but do not need to be located at different locations. For example, the network 3 may be any kind of TCP/IP-based network. Insofar, communication between the computer 1 and the server 2 over the network 3 can be realized using for example any standard or proprietary protocol carried over TCP/IP, and in such protocol the malware scanning agent at the computer 1 and the malware analysis sandbox or application at the server 2 can be represented on/as the application layer.

In one embodiment of the invention the malware analysis environment, service and/or software can detect starting and closing of applications, all unusual processes and attach monitoring to the required applications and processes. Also, when the services are started early, the service is able to detect and follow most of user's applications. In one embodiment of the invention, when the malware detection software or service is started up, it can perform running application inventory.

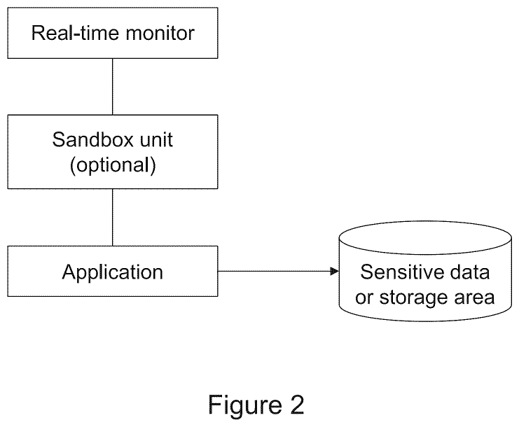

FIG. 2 presents one example embodiment of the invention in which application is monitored according to one embodiment of the invention. In the solution of the invention the device, e.g. a sensor and/or a malware detection agent on the computer, such as a host, detects that an application is starting at the computer. The application start is intercepted, and in one embodiment of the invention reputation or risk rating of the application can be identified. Based on the identified reputation or risk rating of the application a backup of the device can be created. In one embodiment of the invention, if the reputation of the application is unknown (e.g. the application can't be classified as malicious or as a known clean file), a backup is created before the application is allowed to run. The application can be allowed to run after the identification of the reputation and or risk rating e.g. if the application is not considered malware or otherwise harmful. In one embodiment of the invention the reputation or risk rating can be identified by making a request from a server 2, which server may comprise a malware scanning, risk rating and/or reputation database. In one embodiment the server has collected information from different computers for creating a database of the risk ratings of different applications and files. The risk rating information can comprise for example information on the reputation of the application and/or e.g. that a certain application is not malicious or that a certain application is malicious or malware.

In the solution of the invention, the application is monitored when the application is running, e.g. for a predetermined duration after the application start, in order to recognize malicious activity by the application. In the solution of the invention the monitoring comprises monitoring the application for accessing a predefined storage area, e.g. a security sensitive area, of the computer, and if access to the predefined storage area, e.g. the security sensitive area, of the computer is determined during the monitoring, access of the application to the predefined storage area can be denied and/or network access of the monitored application can be denied or throttled. Monitoring of the application can also comprise monitoring all accesses made by the application to the computer and e.g. storage area of the computer in order to find out if the application has malicious behavior or carries out malicious actions. In one embodiment of the invention the method comprises identifying that the application is malware by at least monitoring behavior of the application when the application is running and/or based on signatures of the application.

The predefined storage areas of the computer can for example comprise at least one of the following storage areas and/or data:
user's documents and data,
memory state of applications, such as memory states of browsers, password managers and/or encryption services,
computer registry data, Windows registry data, registry data comprising password or token information, for example, HKEY_LOCAL_MACHINE\SECURITY,
password and key storages.

If the application is determined to be malware when the application is running, the application is stopped, the malware is removed, and changes made to the computer can be reverted based on the said backup of the computer. In one embodiment of the invention removing the malware can comprise at least one of the following actions: terminating the malware processes, deleting registry values pointing to malware components and files. In one example if the application is accessing the predefined storage area, e.g. sensitive data area, the application can also be stopped, the application can be removed, and changes made to the computer can be reverted based on the said backup of the computer, even if the application has not been found to be malicious. Application and/or malware removal can e.g. comprise e.g. terminating application and/or malware processes, deleting register values pointing to application and/or malware components and removing files created or changed by the application and/or malware processes and or files relating to the application and/or detected malware.

The following table presents some examples of settings that can be stored when creating a backup of a computer or a system:

Settings

| | |
|---|---|
| Windows Explorer | Malware sets to hide extension so files with |
| settings e.g. “hide | double extension may look legit e.g. |
| extensions for | program.txt.exe will be looking as text file. |
| known file types” | However, user may set the same setting as |
| | personal choice. |
| Desktop wallpaper | Ransomware commonly sets wallpaper with |
| | ransom note. |
| Windows update | A malware disables Windows update to prevent |
| | their removal with next update. However, system |
| | administrator may disable updates as they are |
| | provided with alternative update mechanism. |
| Windows security | Firewall, anti-ransomware and other settings |
| settings | maybe changed by malware or assigned by |
| | administrator depending on the configuration |
| ect\hostsfile DNS | A malware overrides legit hosts to block |
| overrides | connectivity e.g. set “example.com” as 127.0.0.1 |
| | However, system administrator may change |
| | hostsfile with legit purpose |
| Scheduled task | Some malwares register self to be executed by |
| | system scheduler. Task can run complex chain |
| | of commands and it can be quite hard to connect |
| | malware task to its executables. |
| Volume Shadow Copy | Ransomware disables shadow copy to prevent |
| | data recovery. This also could be disabled by |
| | admin as part of system configuration |

The table is not exhaustive and given as example and any setting of a device, system, service and/or application changed by malware can be included to the created backup in the solution of the invention. In one embodiment of the invention only a part of the settings of the device are included in the backup.

In one embodiment of the invention the method comprises deleting the created backup after the application monitoring is stopped, after the application is considered safe and/or after the computer has been reverted by using the backup.

The following describes as an example embodiment of the invention how the solution can operate. In this example, when an unrated or unknown application is started, its process ID (PID) is noted, and the process is added to set of monitored processes. If any monitored process is starting another process, its PID is added to set of monitored processes. If a process from monitored processes set drops a file e.g. DLL or script and triggers other process to take in to use, the dropped resources, for example run a scheduled task and load dropped DLL into the task, then the triggered process is added into set of monitored processes. If a process from monitored processes set injects a thread into other already running process, the injected thread is added to set of monitored processed. The application is allowed to run the monitored processes undisrupted and events created by the monitored application, such as created or changed files, access and changes of registry, creating child processes, injection in other processes, are captured. Captured events are analysed to see if they are malicious. This can be done e.g. by recognizing known patterns of file encryption and/or prevention from malware detection. If malicious activity or behaviour is detected in the event flow, the monitored application is blocked and terminated. If no malicious activity or behaviour is detected, access by application to the predefined areas, e.g. security sensitive areas, is monitored. If a process from the set of monitored processes accesses the predefined areas, e.g. security sensitive areas, then for example some of these strategies are possible: 1) Deny any access to the data on the predefined area and optionally terminate the process, 2) Deny or throttle the outbound data upstream by the monitored processes, or 3) Stop and remove the application. On the other hand, if during some period of time the monitored application doesn't show the symptoms of unwanted behaviour, such as malicious actions or behaviour, the monitoring can be ended, and application can be let to run without monitoring. While denying any access to data at the predefined area, e.g. security sensitive area, is very secure method, it also reduces usability as it interrupts the behaviour of the application. In case of blocking legit activity of monitored application it may cause user to switch off the protection. Denying or throttling the outbound data upstream reduces the chance of application disruption.

In one embodiment of the invention behaviour-based detection can be used for identifying malicious applications. There are several approaches which can be used, for example host intrusion prevention system (HIPS) and a sandbox service.

A host intrusion prevention system can run in a computer, e.g. an endpoint, where it monitors and evaluates individual operations separately. A host intrusion prevention system may also collect all the operations of an application and upstream them to a backend service to build a reputation or risk rating for the application.

In some scenarios the protection provided by a traditional host intrusion prevention system can be insufficient because malicious behaviour can comprise combinations of multiple operations that are benign by themselves. As a result, a host intrusion prevention system may have to block earlier resulting to false positives and incomplete behaviour upstream. Due to the nature of a host intrusion prevention system, it is also not able to monitor a process indefinitely limiting the number of operations that can be collected. When an host intrusion prevention system choose to block later, it may be too late because a malware may have already caused some damages.

For a sandbox service, an application is usually uploaded to a backend service, where it will be detonated in a virtual machine. The virtual machine and sandbox service can also be used at the local machine, e.g. a computer, an endpoint or host. The service will monitor the behaviour of the application in the virtual machine and use it to build a risk rating for the application. In one embodiment of the invention, virtualization or emulation, such as hardware virtualization, e.g. Hyper-V, software virtualization or emulation can be utilized. Virtual machine or emulator can execute a virtual copy of operating system on local machine or a server, such as a LAN server. In one embodiment a virtual machine or a software emulator can be started and/or initialized in response to starting a software application at a local machine. The software application is passed to the virtual machine or the software emulator. Application events and/or behavior is analyzed at the virtual machine or the software emulator to determine malicious behavior of the application. Based on the detected malicious behavior of the software application at the virtual machine or the software emulator, the local machine is notified about the malicious behavior and the virtual machine.

A sandbox may seem like a better alternative for certain scenarios than a host intrusion prevention system because a sandbox service is able to evaluate multiple operations together and monitor the application or file longer. Sandbox, e.g. as a cloud service, may be expensive to operate and in some cases there may be too many suspicious samples that can be detonated in practice. Malware used in a targeted attack may also behave differently in their target systems than in sandbox.

A sandbox unit which can be utilized in the solution of the invention can in one embodiment of the invention be a group of components that enable tracing of system-wide behaviour of a given application in a contained manner by executing the application with restricted access and/or non-persistent access (changes made by the application may be rolled back). Containment may be achieved by executing the application on the computer, but network can be throttled and/or filtered and system changes are reverted when a behaviour of the application matches certain heuristics. Alternatively, the application may be detonated in a virtual machine running on the endpoint. The application can only be allowed to execute on the computer when its behaviour did not match any heuristics. The unit can be responsible for quarantining the application, and when the application was already executed on the computer, also to revert the system changes e.g. based on the created backup. Likewise, the unit can also be responsible for performing the undo on any quarantine operations. If the malware analysis is done at a virtual machine, reverting the device and/or system settings and/or removal of detected malware may not be necessary.

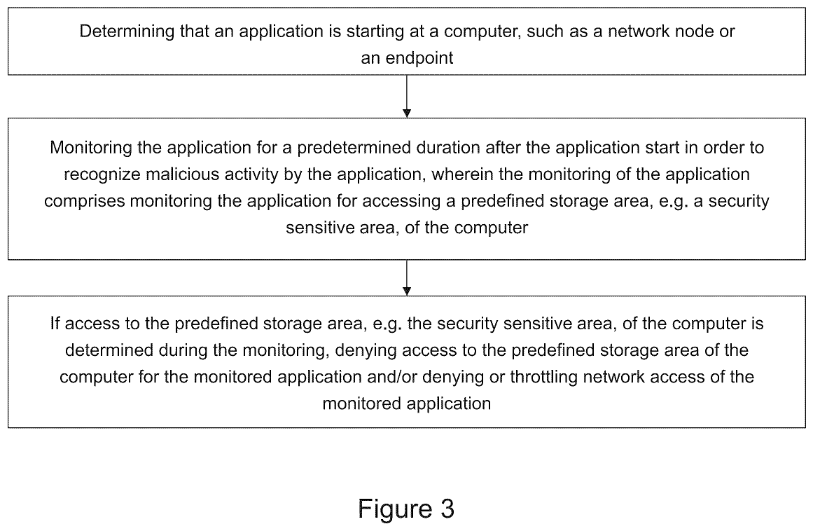

FIG. 3 presents an example method according to one embodiment of the invention. The example method comprises determining that an application is starting at a computer, such as a network node or an endpoint, and monitoring the application for a predetermined duration after the application start in order to recognize malicious activity by the application. The monitoring of the application comprises monitoring the application for accessing a predefined storage area, e.g. a security sensitive area, of the computer, and if access to the predefined storage area, e.g. the security sensitive area, of the computer is determined during the monitoring, denying access to the predefined storage area of the computer for the monitored application and/or denying or throttling network access of the monitored application.

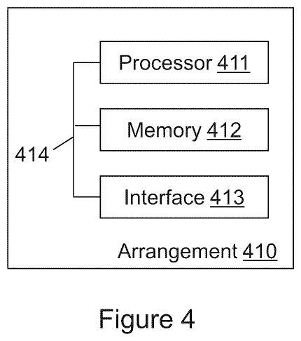

As presented in FIG. 4, an arrangement 410 or at least part of the arrangement, e.g. a computer, an endpoint and/or a server, according to exemplifying embodiments of the present invention may comprise at least one computer which comprises a processor 411 and at least one memory 412 (and possibly also at least one interface 413), which may be operationally connected or coupled, for example by a bus 414 or the like, respectively.

The processor 411 of the arrangement 410 is configured to read and execute computer program code stored in the memory 412. The processor may be represented by a CPU (Central Processing Unit), a MPU (Micro Processor Unit), etc., or a combination thereof. The memory 412 of the arrangement 410 is configured to store computer program code, such as respective programs, computer/processor-executable instructions, macros or applets, etc. or parts of them. Such computer program code, when executed by the processor 411, enables the arrangement 410 to operate in accordance with exemplifying embodiments of the present invention. The memory 412 may be represented by a RAM (Random Access Memory), a ROM (Read Only Memory), a hard disk, a secondary storage device, etc., or a combination of two or more of these. The interface 413 of the arrangement 410 is configured to interface with another arrangement and/or the user of the arrangement 410. That is, the interface 413 may represent a communication interface (including e.g. a modem, an antenna, a transmitter, a receiver, a transceiver, or the like) and/or a user interface (such as a display, touch screen, keyboard, mouse, signal light, loudspeaker, or the like).

The arrangement 410 may, for example, represent a computer 1 or may represent a (part of a) server 2 in FIG. 1. The arrangement 410 may be configured to perform a procedure and/or exhibit a functionality as described in any one of FIGS. 1 to 3.

According to exemplifying embodiments of the present invention, the application to be monitored can be any electronic file, particularly encompassing any electronic file including a runnable/executable part, such as any kind of application file. Insofar, exemplifying embodiments of the present invention are applicable to any such electronic file, including for example a file of an Android Application Package (APK), a Portable Executable (PE), a Microsoft Soft Installer (MSI) or any other format capable of distributing and/or installing application software or middleware on a computer.

The data collected with the solution of the invention may be stored in a database or similar model for information storage for further use.

In an embodiment, further actions may be taken to secure the computer or the computer network when a malicious file, application or activity has been detected. Also actions by changing the settings of the computers or other network nodes can be done. Changing the settings may include, for example, one or more nodes (which may be computers or other devices) being prevented from being switched off in order to preserve information in RAM, a firewall may be switched on at one or more nodes to cut off the attacker immediately, network connectivity of one or more of the network nodes may be slowed down or blocked, suspicious files may be removed or placed into quarantine, logs may be collected from network nodes, sets of command may be executed on network nodes, users of the one or more nodes may be warned that a threat or anomaly has been detected and that their workstation is under investigation, and/or a system update or software patch may be sent from the security backend to the nodes. In one embodiment of the invention one or more of these actions may be initiated automatically.

Although the invention has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein. Lists and groups of examples provided in the description given above are not exhaustive unless otherwise explicitly stated.

1. A method of threat detection in a computer or computer network, the method comprising:
determining that an application is starting at the computer;
monitoring the application for a predetermined duration after a start of the application is determined in order to recognize malicious activity by the application, the monitoring the application comprises monitoring the application for accessing a predefined storage area of the computer; and
one or more of: (i) denying access to the predefined storage area of the computer for the monitored application and (ii) denying or throttling network access of the monitored application, when access to the predetermined storage area of the computer is determined during the monitoring.

2. The method according to claim 1, wherein, when no malicious activity is recognized to be carried out by the monitored application during the predefined duration, one or more of: (i) stopping monitoring and allowing access to the predefined storage area (ii) allowing network access of the monitored application, and (iii) stopping the throttling of the network access.

3. The method according to claim 1, wherein, based on the determined starting of the application,
intercepting the application start,
identifying the application,
checking a reputation rating of the application, and
when the reputation rating of the application is unrated or unknown, allowing the application to start and starting monitoring of the application.

4. The method according to claim 1, wherein, based on the determined starting of the application,
intercepting the application start,
identifying the application,
checking reputation rating of the application, and
when the reputation rating of the application is unrated or unknown, creating a backup of the computer.

5. The method according to claim 4, wherein checking the reputation rating of the application comprises receiving application reputation information from a database based on one or more of: (i) identification and (ii) signatures of the application.

6. The method according to claim 1, wherein the application is monitored by tracking events created by the application, such as created or changed files, accesses to registry, changes done to registry, created processes, created child processes, injection of processes in other processes, and/or by analyzing captured events to be malicious, e.g. by recognizing known patterns of file encryption, preventing malware detection by the application.

7. The method according to claim 1, wherein, when malicious activity by the application is determined when the application is running and/or if the application is accessing the predefined storage area, stopping the application, removing the application and/or reverting changes made to the computer based on the backup of the computer, the backup being prepared when the application was starting.

8. The method according to claim 1, wherein the backup comprises at least one of the following: current system settings, application settings, security settings, DNS-settings, scheduled tasks, and settings related to backups or shadow copy of the computer.

9. The method according to claim 1, wherein the predefined storage area comprises at least one of the following: documents and data of a user of the computer, password data, key storage data, a memory state of the application, a memory state of a password manager, a memory state of an encryption services, computer registry data, windows registry data, and registry data containing one or more of: (i) password information and (ii) token information.

10. An arrangement for threat detection in a computer or computer network, the arrangement comprising:
at least one computer configured to:
determine that an application is starting at a computer,
monitor the application for a predetermined duration after a start of the application is determined in order to recognize malicious activity by the application, the application being monitored for accessing a predefined storage area of the computer, and
one or more of: (i) deny access to the predefined storage area of the computer for the monitored application and (ii) deny or throttle network access of the monitored application, when access to the predefined storage area of the computer is determined during the monitoring.

11. The arrangement according to claim 10, wherein the arrangement is configured to carry out a method including
determining that the application is starting at the at least one computer;
monitoring the application for a predetermined duration after the start of the determined application in order to recognize malicious activity by the application, wherein the monitoring the application comprises monitoring the application for accessing a predefined storage area of the computer,
one or more of: (i) denying access to the predefined storage area of the computer for the monitored application and (ii) denying or throttling network access of the monitored application, when access to the predetermined storage area of the computer is determined during the monitoring, and
when no malicious activity is recognized to be carried out by the monitored application during the predefined duration, one or more of: (i) stopping monitoring and allowing access to the predefined storage area (ii) allowing network access of the monitored application, and (iii) stopping the throttling of the network access.

12. A computer program comprising instructions which, when executed by the computer, cause the computer to carry out the method according to claim 1.

13. A computer-readable medium comprising the computer program according to claim 12.

14. The method according to claim 1, wherein the predefined storage area of the computer is a security sensitive area of the computer.

15. The method according to claim 1, wherein the database is a backend system reputation database.

16. The method according to claim 6, wherein the tracked events created by the application include created or changed files, accesses to registry, changes done to registry, created processes, created child processes, and an injection of processes in other processes

17. The method according to claim 6, wherein the analyzing the captured events to be malicious comprises recognizing known patterns of file encryption, preventing malware detection by the application.
